(19) United States
(12) Patent Application Publication
(10) Pub. No.: US 2026/0351502 A1
(43) Pub. Date: Nov. 5, 2026

(54) VEHICLE PYROTECHNIC CIRCUIT BREAKER CIRCUITRY

(71) Applicant: FORD GLOBAL TECHNOLOGIES, LLC, Dearborn, MI (US)

(72) Inventors: Nicholas Kuhajda, Berkley, MI (US); Jacob Gregory Powers, Livonia, MI (US); Charles Moore, Madison Heights, MI (US); Mykenzie Garza, Canton, MI (US)

(21) Appl. No.: 19/197,598

(22) Filed: May 2, 2025

(51) Int. Cl. H01H 39/00; B60R 16/03; H01H 85/041; H02H 3/087

(52) U.S. Cl. CPC H01H 39/006; B60R 16/03; H01H 85/041; H02H 3/087; H01H 2039/008

(57) ABSTRACT

A vehicle electrical system includes a high voltage bus and a pyrofuse designed to mechanically interrupt the bus when activated. Activation is triggered by a break in a cut loop or a controller command based on excessive current. The system uses switches to power a squib within the pyrofuse. Each switch gate connects to a resistor linked to a power source through a disconnect switch. A squib driver can also independently activate the pyrofuse.

### TECHNICAL FIELD

This disclosure relates to vehicle electrical systems.

### BACKGROUND

Automotive electronics and wiring systems are often structured around a network of interconnected modules, sensors, actuators, and power distribution elements. A foundational component is the wiring harness, which includes bundled wires and connectors routed throughout the vehicle. These harnesses carry both power and data between components.

### SUMMARY

A vehicle electrical system, in one example, includes a high voltage bus and a pyrofuse. The pyrofuse interrupts the bus when activated. A pair of switches and a cut loop control activation. When the loop breaks, the switches power the pyrofuse. The switches are field effect transistors (FETs), specifically N-channel MOSFETs. Each gate is connected to a resistor. These resistors are linked to a power source via a disconnect switch. The pyrofuse includes a squib. One FET connects its source to a squib pin and the other FET connects its drain to another squib pin. One FET's drain connects to the power source through a switch, while the other FET's source connects to ground. A squib driver can also activate the pyrofuse. The driver connects to the power source through a disconnect switch. A controller monitors bus current. If current exceeds a threshold, the controller commands the driver to activate the pyrofuse. All components, including the pyrofuse and switches, are housed in a box.

A pyrofuse is activated in response to a cut loop break in another example. A pair of field effect transistors switch from inactive to active. They then provide power to a squib in the pyrofuse. The pyrofuse activates and interrupts the high voltage bus. A squib driver may be commanded to power the squib. This command is triggered when current on the bus exceeds a set value.

A vehicle in yet another example includes a high voltage bus and a cut loop. It has a disconnect box with a pyrofuse. The pyrofuse interrupts the bus when activated. An activation system powers the pyrofuse when the cut loop breaks. A squib driver can also activate the pyrofuse on command. The disconnect box includes a power source for both the activation system and the squib driver. The activation system contains two switches. The switches respond to the cut loop break. They are metal-oxide-semiconductor field-effect transistors. The vehicle includes a 12V battery that can connect to the disconnect box. A controller monitors the bus current. If the current exceeds a threshold, the controller issues a command to activate the pyrofuse.

### BRIEF DESCRIPTION OF THE DRAWING

FIG. 1 is a schematic diagram of a vehicle electrical system including a pyrotechnic actuator.

### DETAILED DESCRIPTION

Detailed embodiments are described below. These examples are illustrative and not intended to limit the scope of the subject matter, which may take various alternative forms. The figures are not drawn to scale. Certain features may be enlarged or reduced to highlight specific aspects of the components. Accordingly, the structural and functional details provided should be understood as representative, serving to guide those skilled in the art in applying the described concepts in different ways.

A vehicle power distribution system can include a 12V or 48V battery, fuse boxes, and relays. Power is delivered to individual loads through dedicated circuits including fuses or circuit breakers. Relays are used to switch high-current devices using low-current control signals. The main fuse box, or power distribution center, is typically located near the battery and serves as the central hub for routing high-current power.

Control modules, referred to as electronic control units (ECUs) or vehicle control units (VCUs), are distributed throughout the vehicle architecture. Each ECU or VCU is responsible for managing a distinct subsystem. Typical subsystems include engine control (if an engine is present), transmission management, exterior and interior lighting, body electronics, infotainment, power steering, and driver assistance features. These control units operate using embedded microcontrollers or microprocessors, often with integrated memory, analog-to-digital converters, and pulse-width modulation (PWM) outputs. Communication between modules occurs over in-vehicle networking protocols. The most common networks include Controller Area Network (CAN), which supports real-time communication for powertrain and chassis systems; Local Interconnect Network (LIN), used for lower-speed applications such as mirror adjustment or window control; and automotive Ethernet, which supports high-bandwidth data exchange for cameras, sensors, and infotainment systems. Some ECUs support multiple communication protocols simultaneously. Each module interfaces with the vehicle harness via a multi-pin connector, typically sealed and keyed to prevent misconnection. These connectors route power, ground, sensor inputs, actuator outputs, and communication lines. Signal integrity is maintained through proper shielding, twisted-pair routing for differential signals, and termination resistors where required.

Sensors are distributed throughout the vehicle and provide real-time input to ECUs and VCUs. Each sensor is designed to measure a specific physical parameter. Common sensor types include thermistors for temperature measurement, strain gauges or piezoresistive elements for pressure sensing, variable reluctance or Hall-effect sensors for detecting rotational speed, and potentiometric or magnetic encoders for position sensing. Current sensors are also commonly used and include Hall-effect sensors, which detect magnetic fields generated by current-carrying conductors, and shunt-based sensors, which measure the voltage drop across a precision resistor to infer current. More advanced implementations may use fluxgate or magnetoresistive sensing elements for higher accuracy and sensitivity. These current sensors are used in applications such as traction inverters, battery management systems, onboard chargers, electric power steering, and fuse monitoring circuits. Output signals from current sensors can be analog or digital and may include built-in isolation, signal conditioning, or diagnostic features, depending on the specific application requirements. Many sensors use analog voltage or current signals to convey data, while others use digital protocols such as SENT (Single Edge Nibble Transmission), PWM, or LIN. Sensor power is supplied by the vehicle wiring harness, often at 5V or 12V levels, depending on sensor type and subsystem requirements. Ground return paths are routed through the harness back to a common ECU ground or vehicle chassis. Signals from the sensors are routed through shielded or twisted-pair wires to reduce noise and electromagnetic interference. Actuators receive output signals from ECUs or VCUs in response to sensor inputs and internal logic. Actuators include solenoids, electric motors, servos, relays, valves, and stepper motors. Control signals can be binary (on/off), analog (variable voltage or current), or digital (e.g., CAN-based commands for smart actuators). Some actuators include internal position feedback or diagnostic communication capability. Actuation control is typically achieved using PWM signals, H-bridge drivers for bidirectional control, or direct voltage control, depending on the application and load type.

High-current circuits for systems like the starter motor, electric power steering, and electric compressors use heavy-gauge wires and dedicated connectors. These circuits may include inline connectors with built-in current sensing or thermal protection elements.

Lighting systems are routed separately with their own circuits for front, rear, and interior lamps. These circuits are controlled by body control modules and may include pulse-width modulation (PWM) for brightness control.

Modern high-voltage powertrains may include circuits to manage electrical faults. Traditionally, this has been achieved using mechanical contactors and melting fuses, which interrupt current flow under fault conditions.

A newer approach involves the use of pyrotechnic circuit breakers, or pyrofuses, which rely on a small charge to sever a conductive path. At its core is a metal bus bar, usually made of copper, which carries current during normal operation.

The device can include a pyrotechnic actuator called a squib, similar to those used in other systems. When triggered by an electrical signal, the squib produces a controlled reaction. The force is directed at a weakened section of the bus bar, causing it to fracture.

The entire assembly can be housed in a molded enclosure that shields internal components and provides insulation. Some designs include arc suppression features to manage high-voltage disconnection. Some pyrofuse configurations receive trigger signals through an electrical interface connected to the vehicle's control system. Certain models also contain an internal power source, such as a capacitor or battery, allowing activation even if the main power supply is unavailable.

Upon activation, the squib either breaks the bus bar directly or drives a blade through it. This creates a permanent open circuit in a few milliseconds. The pyrofuse is often replaced after activation. Compared to traditional melting fuses and mechanical contactors, pyrofuses offer faster response times and, in some cases, a more compact form factor while handling similar voltage and current levels.

Certain pyrofuse arrangements may present design and implementation constraints. They require a consistent power source to activate the triggering mechanism, and their integration depends on components and control software that meet automotive system standards. Without a mechanical contactor capable of isolating the full voltage and current, addressing all operational scenarios in a high-voltage electrical distribution system may require additional considerations.

In some operating conditions—such as a complete loss of power or a major electrical fault—a vehicle may be left without conventional control pathways. Under these circumstances, the ability to actuate a pyrofuse using alternate pathways may be required. A ruggedized activation system offers a means of triggering the pyrofuse in these scenarios, including environments with degraded power or disrupted communications.

Some proposed pyrotechnic circuit breakers, instead of using integrated circuits or dedicated squib drivers, rely on a metal-oxide-semiconductor field-effect transistor (MOSFET) trigger controlled by a ground loop. A small internal power supply with low leakage current keeps the system operational long after low-voltage power is lost.

The design includes, for example, an N-Channel MOSFET. Its gate pin is normally held at the same potential as the source pin, keeping the device open. To activate the MOSFET, a voltage difference must be created between the gate and source. This is achieved using a pull-up resistor on the gate pin. The resistor has a high resistance value to reduce leakage.

The system uses a loop, known as the cut loop, which connects the gate and source pins, typically to ground. The primary components of a cut loop are insulated copper wires, often jacketed with thermoplastic materials rated for automotive environments. These wires are routed through specific zones of the vehicle where interruption may occur, such as along structural members, body panels, sensors, or manually accessible points. The loop may include intermediate connectors or junctions, but these should maintain continuous electrical connectivity under normal conditions. At the MOSFET interface, the loop can be soldered or crimped to the gate and source terminals, forming a low-resistance path to keep the transistor disabled.

A pull-up resistor can be connected between the gate and a higher voltage potential, typically the internal energy storage node. This resistor has a high value, often in the range of hundreds of kilo-ohms to mega-ohms, which limits leakage current while providing a default high state when the loop is broken. The resistor is not physically part of the loop but plays a role in setting the gate voltage once the loop is open.

Cut loops can be arranged in several ways depending on the application. A single continuous loop can be routed through multiple locations to create redundant break points. Alternatively, several or serial loop segments can be used, each routed to different parts of the vehicle. The design can also incorporate intentionally weakened sections or mechanical interfaces that are likely to separate under specific conditions, such as during deformation of structures or when a panel is removed.

Routing strategies vary depending on the physical constraints and triggering requirements. Some implementations run the loop through molded guides, grommets, or brackets to stabilize its path and prevent false breaks. Others integrate the loop into the vehicle's wiring harness using shielding and strain relief to maintain integrity during operation. The loop may also be printed onto flexible or rigid circuit boards if integration with electronic components is needed.

The termination of the cut loop at the activation circuit should account for electromagnetic noise, vibration, and environmental exposure. Shielded cables, twisted pair wiring, or filter components may be included depending on system-level noise considerations.

When the loop is broken—mechanically or electrically—the gate voltage rises due to the pull-up resistor, activating the MOSFET and allowing current to flow to the downstream load, such as a pyrofuse. That is, the gate pin voltage rises through the pull-up resistor. This closes the MOSFET and delivers power directly to the pyrofuse. The circuit reacts quickly, with switching times in the nanosecond range. Running the cut loop through structural elements can allow rapid high-voltage disconnection even if low-voltage systems are offline.

In one example, a system includes an 18-farad ultracapacitor and a basic low-volume printed circuit board. The system can remain functional for hours or days after power loss and does not rely on software. Using a break-to-activate approach also reduces the chance of fault from open wiring in the cut loop.

This activation system offers a method for controlling pyrofuses. It simplifies design in certain circumstances and allows fast disconnection of high-voltage circuits without relying on complex electronics or software.

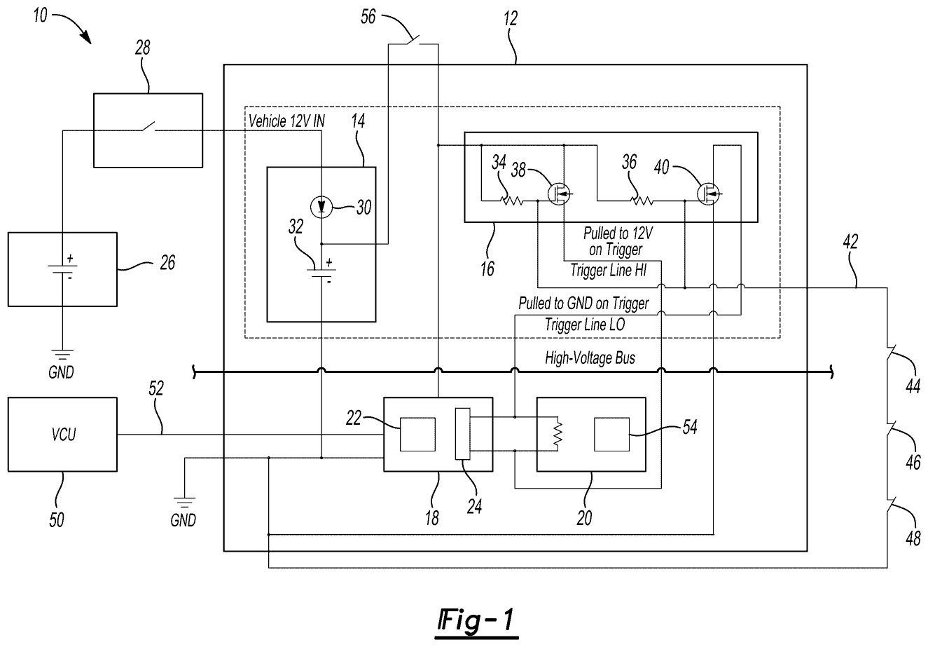

Referring to FIG. 1, a vehicle 10 includes a high-voltage disconnect mechanism based on a pyrofuse, which is activated through either a squib driver or a redundant cut-loop-based trigger system. The components in this example are organized into functional subsystems, some of which are further nested within larger system enclosures, following a modular electrical architecture. Other arrangements are also contemplated.

At the top level, an active disconnect box 12 encloses several major components: a protected 12V source 14, an activation system 16, an activator unit 18, and a pyrofuse 20. The activator unit 18 contains both a current measuring device 22 and an internal squib driver 24. The pyrofuse 20 is located downstream of the activator unit and is the final load in the trigger circuit.

The system is powered by a 12V battery 26. This battery is connected in series with a relay 28, which allows manual or controlled disconnection of the main power. The output of the relay 28 feeds the Vehicle 12V IN line entering the active disconnect box 12.

Inside the active disconnect box 12, the Vehicle 12V IN connects to the protected 12V source 14. This module includes an isolation diode 30, which blocks reverse current, and an internal power source 32, such as a backup capacitor or auxiliary battery. The protected output from this unit provides voltage to both the activation system 16 and to the activator unit 18, including the squib driver 24.

The activation system 16, in this example, includes two parallel branches, each containing a 10 MΩ pull-up resistor 34, 36 and an N-channel MOSFET 38, 40. These branches are powered by the protected 12V line. Each MOSFET has its gate and source connected through a cut loop 42. When the cut loop 42 is intact, the gates are held low relative to the sources, keeping the MOSFETs 38, 40 off. If the cut loop 42 is broken, the gate voltages rise via the pull-up resistors 34, 36, turning the MOSFETs 38, 40 on. Current can then flow from the drains to the sources, creating a path from 12V through the squib 24 and activating the pyrofuse 20.

The cut loop 42, in this example, is routed through three separate access points in the vehicle 10: driver compartment 44, left window 46, and right window 48. These branches are electrically wired such that any one being severed breaks the ground reference to the MOSFET gates, allowing the gates to be pulled high and closing the circuit. Trigger Line HI in the diagram represents the high side 12V path connected to the pull-up resistors 34, 36. Trigger Line LO is the shared ground connection routed through the cut loop path.

The activator unit 18, as mentioned above, includes the current measuring device 22 and the squib driver 24. The current measuring device 22 monitors the flow of current through High-Voltage Bus and reports this information to a VCU 50 via a CAN bus 52. The squib driver 24, can receive activation commands and apply a drive signal to the pyrofuse 20. The VCU 50 is responsible for issuing those commands, using the CAN bus 53 for communication. It is powered and grounded separately, with a connection to chassis ground.

The squib driver 24 sends its output to the pyrofuse 20, which includes squib 54 and a 2.2 Ω resistor representing the characteristic load of the squib 54. This resistor is connected between two terminals associated with the squid driver 24. The squib 54 is activated when a voltage is applied across these two pins, either by the squib driver 24 or by the alternative MOSFET path in the activation system 16.

The squib 54 is driven using two lines: Trigger Line HI and Trigger Line LO. Trigger Line HI is pulled to 12V on activation, while Trigger Line LO is pulled to ground. These lines originate from the activation system 16 and are routed directly across the squib 54. Activation System GND provides a current return path.

A manual service disconnect switch 56 is installed in series with the Vehicle 12V IN. This switch provides a physical disconnection method for maintenance or service, breaking the 12V feed to the active disconnect box 12 when opened.

The system provides two separate methods to activate the pyrofuse 20. The first is through software control, using the squib driver 24, commanded by the VCU 50 over CAN. The second is a hardware path, using the MOSFETs 38, 40 in the activation system 16 and the cut loop 42 as the trigger mechanism. In both cases, when a voltage is applied across the squib 54, the pyrofuse 20 is triggered and mechanically interrupts the High-Voltage Bus.

The activation system above uses discrete N-channel MOSFETs with gate-source loops routed through physical cut loops and pull-up resistors to control activation of a squib in a pyrofuse. One alternative implementation could replace the discrete MOSFETs and resistors with an integrated gate driver integrated circuit (IC). This IC could incorporate built-in pull-up functionality, under-voltage lockout, and gate discharge circuits. The gate input could still be controlled through an external cut loop, connected via an enable pin or logic input, but the integration would reduce discrete wiring.

Another possible configuration is to utilize a dual-redundant solid-state switch architecture. In this version, two independently controlled power MOSFETs or GaN FETs could be placed in series between the protected 12V supply and the squib terminals. Each switch would be governed by a separate cut loop routed through distinct physical areas of the vehicle. Only when both loops are broken would the switches close, providing a higher level of fault containment through logical AND activation. A microcontroller could be used as a supervisory element to monitor cut loop continuity through high-impedance sensing and provide diagnostic data over CAN, while not participating directly in the activation path.

A further variation could involve using a relay or a pyrotechnic actuator with an integrated mechanical release, triggered by a small high-energy capacitor bank. In this approach, the cut loop would initiate a passive circuit that releases stored energy into the actuator upon loop break. This method eliminates the need for continuous low leakage current paths and uses energy storage to deliver the necessary pulse to fire the squib. The triggering circuit could be designed entirely using passive components such as resistors, diodes, and zener-controlled charging paths.

The algorithms, methods, or processes disclosed herein can be deliverable to or implemented by a computer, controller, or processing device, which can include any dedicated electronic control unit or programmable electronic control unit. Similarly, the algorithms, methods, or processes can be stored as data and instructions executable by a computer or controller in many forms including, but not limited to, information permanently stored on non-writable storage media such as read only memory devices and information alterably stored on writeable storage media such as compact discs, random access memory devices, or other magnetic and optical media. The algorithms, methods, or processes can also be implemented in software executable objects. Alternatively, the algorithms, methods, or processes can be embodied in whole or in part using suitable hardware components, such as application specific integrated circuits, field-programmable gate arrays, state machines, or other hardware components or devices, or a combination of firmware, hardware, and software components.

The words used in the specification are words of description rather than limitation, and it is understood that various changes may be made without departing from the spirit and scope of the disclosure.

As previously described, the features of various embodiments may be combined to form further embodiments that may not be explicitly described or illustrated. While various embodiments may have been described as providing advantages or being preferred over other embodiments or prior art implementations with respect to one or more desired characteristics, those of ordinary skill in the art recognize that one or more features or characteristics may be compromised to achieve desired overall system attributes, which depend on the specific application and implementation. As such, embodiments described as less desirable than other embodiments or prior art implementations with respect to one or more characteristics are not outside the scope of the disclosure and may be desirable for particular applications.

What is claimed is:

1. A vehicle electrical system comprising:
a high voltage bus;
a pyrofuse configured to, when activated, mechanically interrupt the high voltage bus; and
a pair of switches and a cut loop configured such that, responsive to a break in the cut loop, the switches provide power to the pyrofuse to activate the pyrofuse.

2. The vehicle electrical system of claim 1, wherein the switches are field effect transistors.

3. The vehicle electrical system of claim 2 further comprising a pair of resistors each directly connected with a gate of one of the field effect transistors.

4. The vehicle electrical system of claim 3 further comprising a power source and a disconnect switch, wherein the resistors are connectable with the power source via the disconnect switch.

5. The vehicle electrical system of claim 2, wherein the pyrofuse includes a squib, a source of one of the field effect transistors is directly connected to a pin of the squib, and a drain of the other of the field effect transistors is directly connected to another pin of the squib.

6. The vehicle electrical system of claim 5 further comprising a power source and a disconnect switch, wherein a drain of the one of the field effect transistors is connectable with the power source via the disconnect switch, and a source of the other of the field effect transistors is directly connected to chassis ground.

7. The vehicle electrical system of claim 1 further comprising a squib driver configured to provide power to the pyrofuse to activate the pyrofuse.

8. The vehicle electrical system of claim 7 further comprising a power source and a disconnect switch, wherein the squib driver is connectable with the power source via the disconnect switch.

9. The vehicle electrical system of claim 7 further comprising a current sensor configured to detect current on the high voltage bus and a controller programmed to, responsive to a magnitude of the current exceeding a value, command the squib driver to provide power to the pyrofuse.

10. The vehicle electrical system of claim 1, wherein the switches are N-channel metal-oxide-semiconductor field-effect transistors.

11. The vehicle electrical system of claim 1 further comprising a box, wherein the pyrofuse and switches are disposed within the box.

12. A method comprising:
as a result of a break in a cut loop of a vehicle, transitioning a pair of field effect transistors from being inactive to active such that the field effect transistors provide power to a squib of a pyrofuse to activate the pyrofuse and mechanically interrupt a high voltage bus associated with the pyrofuse.

13. The method of claim 12 further comprising commanding a squib driver to provide power to the squib to activate the pyrofuse.

14. The method of claim 13, wherein the commanding is responsive to a magnitude of current on the high voltage bus exceeding a value.

15. A vehicle comprising:
a high voltage bus;
a cut loop; and
a disconnect box including a pyrofuse configured to, when activated, mechanically interrupt the high voltage bus, an activation system configured to, responsive to a break in the cut loop, provide power to the pyrofuse to activate the pyrofuse, and a squib driver configured to, responsive to a command, provide power to the pyrofuse to activate the pyrofuse.

16. The vehicle of claim 15, wherein the disconnect box further includes a power source configured to selectively provide power to the activation system and the squib driver.

17. The vehicle of claim 15, wherein the activation system includes a pair of switches configured to activate responsive to the break in the cut loop.

18. The vehicle of claim 17, wherein the switches are metal-oxide-semiconductor field-effect transistors.

19. The vehicle of claim 15 further comprising a 12V battery configured to be selectively connected with the disconnected box.

20. The vehicle of claim 15 further comprising a controller programmed to, responsive to a magnitude of current on the high voltage bus exceeding a value, generate the command.
